(19) United States
(12) Patent Application Publication
(10) Pub. No.: US 2006/0171774 A1
(43) Pub. Date: Aug. 3, 2006

(54) Sectile assembly device with screw for an electrical apparatus

(75) Inventors: Laurent Chaumette, Sassenage (FR); Laurent Aureyre, Crolles (FR)

Correspondence Address: STEPTOE & JOHNSON LLP, 1330 CONNECTICUT AVENUE, N.W., WASHINGTON, DC, 20036, US

(73) Assignee: SCHNEIDER ELECTRIC INDUSTRIES SAS, Rueil Malmaison (FR)

(21) Appl. No.: 11/329,131

(22) Filed: Jan. 11, 2006

(30) Foreign Application Priority Data
Feb. 1, 2005 (FR) 05 00994

(51) Int. Cl. F16G 11/00

(52) U.S. Cl. 403/41

(57) ABSTRACT

The invention relates to an assembly device by screwing with tightening torque limiting, comprising a screw provided with a screw head and with a threaded shank defining a geometric reference axis, a sectile monoblock tightening end-piece provided with a tightening head having a tightening profile, with a coupling profile to operate in conjunction with the screw head and with a breaking zone. An insulating sleeve is molded onto the tightening end-piece and the screw head. The sleeve is provided with first coupling means to secure the tightening head and the coupling profile and with second coupling means to secure the screw head and the coupling profile. Said second coupling means comprise a first portion securedly fixed in rotation to the tightening head, a second portion securedly fixed in rotation to the screw head, and a sectile third intermediate portion. The device comprises, at the top part of the screw head, a radial offset between the inside wall of the sleeve and the inside wall of the tightening profile, the intermediate shank resting on a rim formed by a portion of the top part of the screw head.

### BACKGROUND OF THE INVENTION

The invention relates to an assembly device by screwing with tightening torque limiting, comprising a screw provided with a screw head and with a threaded shank defining a geometric reference axis, a sectile monoblock tightening end-piece provided with a tightening head having a tightening profile, with a coupling profile to operate in conjunction with the screw head and with a breaking zone. An insulating sleeve is molded onto the tightening end-piece and the screw head. The sleeve is provided with first coupling means to secure the tightening head and the coupling profile and with second coupling means to secure the screw head and the coupling profile. Said second coupling means comprise a first portion securedly fixed in rotation to the tightening head, a second portion securedly fixed in rotation to the screw head, and a sectile third intermediate portion.

### STATE OF THE PRIOR ART

Numerous patents GB 898,026, FR 2,593,572, FR 2,791,404 describe assembly devices comprising sectile screws enabling the tightening torque to be limited when assembly of two parts is performed.

Among the existing solutions, the solution of the applicant set forth in the document FR 2,840,373 describes an assembly device comprising a screw 10 and a monoblock tightening end-piece 12 that enables and imposes calibrated tightening with a tightening torque that is both high and precise when the screw 10 is fitted. This solution is particularly suitable for an electrical environment on account of the fact that certain parts of the device are electrically insulated by means of an insulating sleeve 14.

The insulating sleeve 14 is cast on the metal parts 12, 24 by hot molding.

Use of the mold-cast plastic sleeve 14 may however present certain drawbacks. The insulating material positioned when hot can in fact infiltrate between the metal parts 12, 14 and cause sticking thereof. Removal of the tightening end-piece 12 after tightening may therefore require a fair amount of force.

### SUMMARY OF THE INVENTION

The object of the invention is therefore to remedy the shortcomings of the state of the art so as to propose an assembly device that imposes high and precise, calibrated tightening, and that is easy to disassemble after tightening.

The assembly device according to the invention comprises, at the top part of the screw head, a radial offset between the inside wall of the sleeve and the inside wall of the tightening profile, the intermediate shank resting on a rim formed by a portion of the top part of the screw head.

Preferably, the rim forms an angle α substantially equal to 90 degrees with respect to the geometric reference axis.

In a particular embodiment, the rim has a conical shape having an angle α comprised between 20 and 90 degrees with respect to the geometric reference axis.

In a second particular embodiment, the rim has a curved shape in the form of a portion of an arc of a circle or a parabola.

### BRIEF DESCRIPTION OF THE FIGURES

Other advantages and features will become more clearly apparent from the following description of particular embodiments of the invention, given as non-restrictive examples only, and represented in the accompanying drawings in which:

FIG. 1 represents an assembly device according to a known embodiment, in axial cross-section;

FIG. 2 represents an assembly device according to an embodiment of the invention, in axial cross-section;

FIGS. 3 and 4 represent schematic views, in axial cross-section, of alternative embodiments of the invention according to FIG. 2.

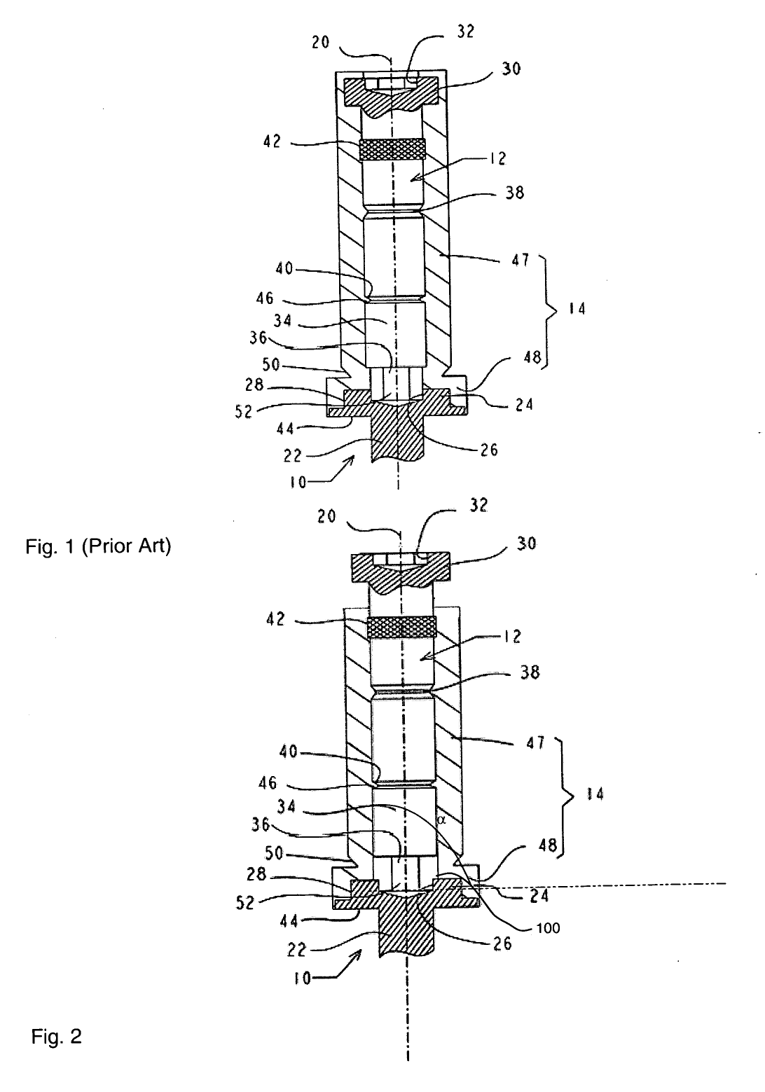

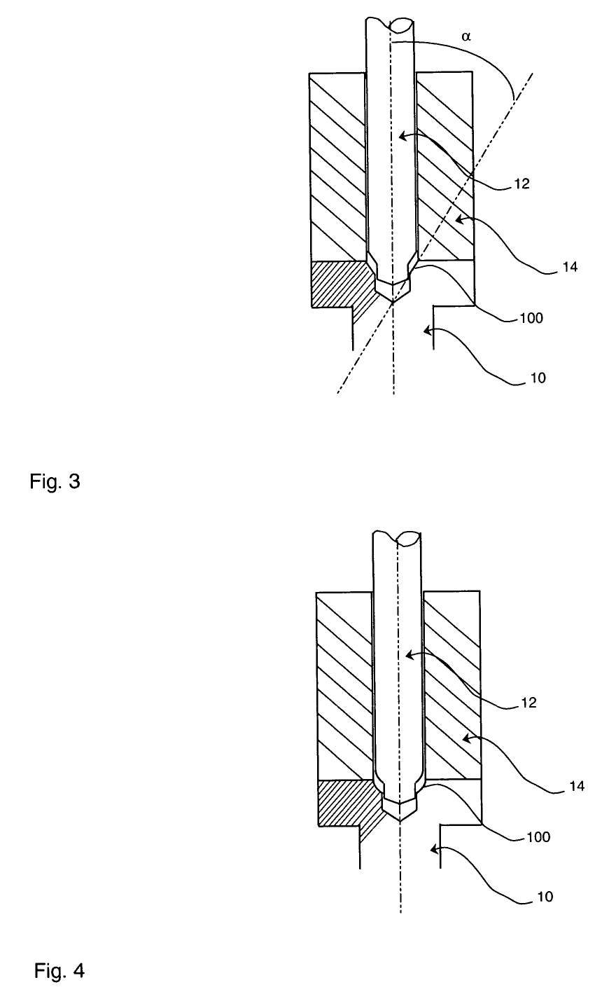

### DETAILED DESCRIPTION OF AN EMBODIMENT

With reference to FIG. 2, an assembly device according to an embodiment of the invention presents itself, before assembly, as a superposition of a metal screw 10, a monoblock tightening end-piece 12 also made of metal, and an insulating sleeve 14 made of synthetic material surrounding the tightening end-piece 12 and the head 24 of the screw 10, these elements having a common geometric reference axis 20. The screw 10 comprises a threaded shank 22 presenting a spiral of axis 20 and a cylindrical head 24 forming a tightening profile 26. As represented in the figure, for example purposes, the tightening profile 26 is a sunken hexagonal profile. The cylindrical periphery 28 of the head 24 is knurled. The tightening end-piece 12 comprises a cylindrical head 30 provided with a tightening profile 32 identical to that of the screw head 24, an intermediate shank 34 and an end 36 pressed into the tightening profile 26 of the screw head 24. The male end 36, of hexagonal cross-section, corresponds to the shape of the sunken hexagonal tightening profile 26.

A breaking neck 38, in practice a notch, is formed on the intermediate shank 34 between the two ends thereof and divides the end-piece 12 into a top part comprising the head 30 and a bottom part comprising the hexagonal end 36. A radial groove 40 is formed between the neck 38 and the hexagonal end 36. Between the head 30 and the neck 38, a portion of the shank comprises a knurled profile 42.

The insulating sleeve 14 is molded on around the tightening end-piece 12 and the screw head 24, leaving the sunken hexagonal tightening profile 32 of the head 30 of the end-piece 12 accessible. The sleeve forms a body 47 covering the end-piece 12 and a skirt 48 that covers the screw head 24. The shank 22 of the screw and the rim 44 formed by the bottom part of the screw head 24 are not covered. A radial breaking notch 50 situated just above the screw head 24 separates the body 47 from the skirt 48. The knurled portions 28, 42 of the screw head 24 and of the intermediate shank 34 of the tightening end-piece constitute zones respectively securing the sleeve 14 and the screw 10 to one another on the one hand, and the sleeve 14 and the top part of the end-piece 12 on the other hand. An internal rib 46 is formed at the level of the groove 40 when molding of the sleeve 14 is performed. First means for coupling in translation along the axis 20 are thus achieved, between the tightening head 30 and the hexagonal end 36, by means of the knurled zone 42, the body 47 of the sleeve 14 and the rib 46 inserted in the groove 40. Second means for coupling in translation are also obtained between the screw head 24 and the hexagonal end 36, by means of the knurled zone 28, the skirt 48, the notch 50, the body 47 of the sleeve 14 and the rib 46 inserted in the groove 40.

All of these features are described in the patent FR 2,840,373 filed by the applicant, the description whereof is on these points incorporated here by reference.

A radial offset exists at the level of the top part of the screw head 24, between the inside wall of the sleeve 47 and the wall of the tightening profile 26. On account of this offset, the intermediate shank 34 rests on a rim 100 formed by a portion of the top part of the screw head 24.

According to the preferred embodiment of the invention, the rim 100 forms an angle α substantially equal to 90 degrees with respect to the geometric reference axis 20.

Thus, in a direction perpendicular to the reference axis 20, the sleeve 47 is offset with respect to the tightening profile 26. When the sleeve 47 is molded onto the tightening end-piece 12 and onto the screw head 24, the risk of molten material penetrating or infiltrating into the tightening profile 26 is greatly reduced on account of this original arrangement; these infiltrations of material causing the end 36 of the intermediate part 34 to stick inside the screw head 24.

In addition, on account of this geometric configuration, the forces required to remove the tightening end-piece 12 are reduced by a factor of more than 10.

To fit the screw 10, the monoblock assembly device is presented in the tightening position, and a hexagonal male spanner inserted in the head 30 of the end-piece is used to tighten the device along the axis 20. The tightening torque is almost totally transmitted by the intermediate shank 34 to the screw head 24 and the sleeve 14 is hardly solicited at all. When the screw 10 blocks, the operator still has to impose a sufficient torque to break the intermediate shank 34 at the level of the breaking zone 38. This breaking torque is calibrated to correspond to the tightening torque required for the screw 10 in its application. Once the neck 38 has been broken, the head 30 of the end-piece remains secured to the screw head 24 by means of the sleeve 14. As the end of the sleeve 14 secured to the screw head 24 by the knurled zone 28, a small torque exerted on the head 30 and transmitted to the sleeve 14 at the level of the knurled zone 42 suffices to make the sleeve 14 break at the level of the notch 50. The assembly device is then separated into two parts: the screw 10 on the one hand, the head 24 whereof is insulated by the skirt 48 of the sleeve, and the sub-assembly formed by the end-piece 12 and the top part of the sleeve 14 on the other hand. This sub-assembly presents a cylindrical insulating surface over most of its periphery, which prevents any risk of short-circuit if this sub-assembly is forgotten.

It should be noted that the device imposes a precise tightening torque of the screw corresponding to the breaking torque of the neck, for so long as the neck and sleeve have not been broken, the device remains in one piece, and the dimensions of the end-piece prevent any assembly operations that are to be performed subsequent to tightening of the screw. Nor is it possible to tamper with the torque limiter, as the screw 10 does not offer any grip so long as it is secured to the end-piece 12, thus guaranteeing that the screw 10 is not tightened beyond the breaking torque. Finally, breaking at the level of the notch 50 gives access to the sunken hexagonal profile of the screw head, via an aperture 52 freed by the hexagonal end 36, enabling the screw 10 to be removed if required. The disassembly tool can be identical to the assembly tool since the assembly profiles 26 of the head of the screw and those 32 of the head of the end-piece are identical.

According to a first alternative embodiment of the invention, the radial offset between the inside wall of the sleeve 47 and the wall of the tightening profile 26 forms a conical rim 100 having an angle α comprised between 20 and 90 degrees with respect to the geometric reference axis 20.

According to a second alternative embodiment of the invention, the radial offset between the inside wall of the sleeve 47 and the wall of the tightening profile 26 forms a rim 100 of curved shape in the form of an arc of a circle or a parabola.

1. Assembly device by screwing with tightening torque limiting, comprising a screw provided with a screw head and with a threaded shank defining a geometric reference axis, a sectile monoblock tightening end-piece provided with a tightening head having a tightening profile, with a coupling profile to operate in conjunction with the screw head and with a breaking zone, an insulating sleeve molded onto the tightening end-piece and the screw head provided with first coupling means to secure the tightening head and the coupling profile and with second coupling means to secure the screw head and the coupling profile, said second coupling means comprising a first portion securedly fixed in rotation to the tightening head, a second portion securedly fixed in rotation to the screw head, and a sectile third intermediate portion, comprising, at the top part of the screw head, a radial offset between the inside wall of the sleeve and the inside wall of the tightening profile, the intermediate shank resting on a rim formed by a portion of the top part of the screw head.

2. Device according to claim 1, wherein the rim forms an angle substantially equal to 90 degrees with respect to the geometric reference axis.

3. Device according to claim 1, wherein the rim has a conical shape having an angle comprised between 20 and 90 degrees with respect to the geometric reference axis.

4. Device according to claim 1, wherein the rim has a curved shape in the form of a portion of an arc of a circle or a parabola.
